(19) United States
(12) Patent Application Publication
(10) Pub. No.: US 2022/0119319 A1
(43) Pub. Date: Apr. 21, 2022

(54) CARBONATION OF FIBER CEMENT PRODUCTS

(71) Applicants: ETEX SERVICES NV, Kapelle-op-den-Bos (BE); COMPTOIR DU BATIMENT NV, Kapelle-op-den-Bos (BE)

(72) Inventors: Valérie SPAETH, Kapelle-op-den-Bos (BE); Luc VAN DER HEYDEN, Boortmeerbeek (BE); Bertrand VAN ACOLEYEN, Kapelle-op-den-Bos (BE); Maarten MILIS, Merchtem (BE); Geert VAN KELECOM, Halle (BE)

(21) Appl. No.: 17/290,883

(22) PCT Filed: Nov. 14, 2019
(86) PCT No.: PCT/EP2019/081398

§ 371 Date: May 3, 2021

(30) Foreign Application Priority Data
Nov. 14, 2018 (EP) 18206230.7

(51) Int. Cl. C04B 40/02; C04B 28/02; C04B 14/30; C04B 18/24; C04B 16/06; C04B 14/06; C04B 14/10; C04B 22/06; C04B 14/28; C04B 14/04

(52) U.S. Cl. CPC C04B 40/0231; C04B 28/02; C04B 14/308; C04B 18/24; C04B 16/0641; C04B 16/0633; C04B 2111/21; C04B 14/106; C04B 22/06; C04B 14/28; C04B 14/043; C04B 40/0263; C04B 40/0281; C04B 14/06

(57) ABSTRACT

The present invention relates to a process for providing a fiber cement product, the process comprising the steps of (a) providing an uncured fiber cement product, (b) curing the uncured fiber cement product, (c) optionally abrasive blasting of at least part of the surface of the cured fiber cement product, (d) treating the cured fiber cement product with CO2 (so-called carbonation) at a concentration of 0.01 to 100%, at a temperature of 5 to 90° C., relative humidity of to 99% for a period of 1 minute to 48 hours. The obtained fiber cement products show less efflorescence.

### FIELD OF THE INVENTION

The present invention relates to fiber cement products and the production thereof and in particular to carbonation of fiber cement products in order to reduce or altogether eliminate efflorescence formation on the fiber cement.

### BACKGROUND OF THE INVENTION

Fiber cement products, in particular sheets or panels, are well known in the art. They typically comprise cement, fillers, fibers, such as process fibers in case a Hatschek process is used, e.g. cellulose fibers, reinforcing fibers, e.g. polyvinyl alcohol (PVA) fibers, cellulose fibers, polypropylene (PP) fibers and alike, and additives. In case the fiber cement products are air cured, also fillers like limestone can be used. When the fiber cement product is autoclave cured, a silicate source, like sand, is added. The resulting products are well known as temporary or permanent building materials, e.g. to cover or provide walls or roofs, such as roof tiles, or façade plates and alike.

Fiber cement products are well known and widely used as exterior building materials, for example, as roofing and/or siding materials.

Fiber cement products being exposed to the outside environment frequently suffer from what is generally called efflorescence. Efflorescence is a natural occurrence when using cement-based products subject to exterior or wet environments and is generally defined as the formation of salt deposits, usually white, occurring on or near the surface of a porous material such as fiber cement. Under appropriate ambient conditions, like humidity, salts typically included in the cured fiber cement material, can migrate to the surface of the fiber cement product, where a white spot becomes visible. Any type of cement is susceptible to efflorescence but reacted Portland cement represents the key contributor to efflorescence.

This phenomena does not decrease or affect the mechanical properties of the fiber cement product but is seen as a visual defect. It may take a long period, like months, before this efflorescence phenomena becomes visible.

Early efflorescence can be removed with a brush and water. It can also be removed by hand washing with mild detergent and stiff bristle brush. But for heavy deposits, diluted hydrochloric acid may have to be used, or alternatively zinc sulphate, sulphuric acid, acetic acid, citric acid, glycolic acid, formic acid or baking soda instead of diluted hydrochloric acid.

Traditionally, people have also been using sandblasting for cleaning efflorescence. But unfortunately this method erodes the surface because of the abrasive action and increases the porosity of the surface. If the surface is not properly sealed with a waterproofing material, then the porous cement will absorb water (moisture) and thus the efflorescence will re-appear.

To reduce the risk of efflorescence, the fiber cement product can be provided with a hydrophobic sealant, rendering the surface of the product more hydrophobic. As such, the penetration of water, which seems to be necessary to allow the salts to migrate to the surface, can be reduced.

The efflorescence problem may never be eliminated. However, it can be controlled and contained, and measures can be taken to drastically reduce the potential for its occurrence.

Therefore it is desirable to find an alternative method to drastically reduce the potential for the occurrence of efflorescence.

### SUMMARY OF THE INVENTION

An objective of the present invention is to provide a more effective way to limit or prevent the spread of efflorescence on fiber cement products exposed to exterior or wet environments without detrimentally affecting the other properties of said products, in particular the mechanical properties and the product's visual aspect.

In this regard, the present inventors have developed a novel method for producing and/or treating fiber cement products. The fiber cement products obtained show remarkably reduced efflorescence. The use of hydrophobation additives in the fiber cement slurry, the use of a hydrophobation coating or agent on the surface of the cured fiber cement or the provision of a translucent or clear coating, all known methods to reduce or avoid efflorescence may be avoided by the present method.

In a first aspect, the present invention provides a process for providing a fiber cement product, the process comprising the steps of

(a) providing an uncured fiber cement product,
(b) curing the uncured fiber cement product in a standard way such as by air-curing or hydrothermal curing (also called autoclave),
(c) optionally abrasive blasting of at least part of the surface of the cured fiber cement product,
(d) treating the cured fiber cement product with CO₂ (so-called carbonation) at a concentration of 0.01 to 100%, at a temperature of 5 to 90° C., relative humidity of 30 to 99% for a period of 1 minute to 48 hours.

By subjecting cured fiber cement products to carbonation at the conditions specified above efflorescence is limited or even avoided on the produced fiber cement products.

Contrary to prior art carbonation processes the carbonation step in the present process takes place on cured fiber cement products whereas in the prior art processes the carbonation process takes place pre-curing and/or assists the curing of said products.

BR 102015000055-3 relates to accelerated hydration of fiber cement in the presence of excess CO₂ at atmospheric pressure to improve mechanical resistance, resistance to weathering, dimensional stability, durability, porosity and water absorption. There is no mentioning of any potential effect on efflorescence. The carbonation is used to ensure complete curing of the fiber products and is applied immediately after molding or during the first hours of cure.

In a second aspect, the present invention provides the fiber cement products obtained by said process.

In a third aspect, the present invention provides the use of the abovementioned CO₂ treatment to limit or prevent the occurrence of efflorescence on the outer surface of fiber cement products exposed to a humid environment.

In a fourth aspect, the present invention provides the use of the obtained fiber cement products as covering of a building construction, for example to provide walls or roofs.

The independent and dependent claims set out particular and preferred features of the invention. Features from the dependent claims may be combined with features of the independent or other dependent claims, and/or with features set out in the description above and/or hereinafter as appropriate.

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention.

The independent and dependent claims set out particular and preferred features of the invention. Features from the dependent claims may be combined with features of the independent or other dependent claims, and/or with features set out in the description above and/or hereinafter as appropriate.

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

### BRIEF DESCRIPTION OF THE DRAWINGS

FIG. 1 shows a graph of the Charpy impact resistance (in relative % compared to Sample 1) of fiber cement samples 1 to 8 as produced with the compositions represented in Table 1. Charpy impact resistance was measured 29 days after production and air-curing (samples 1 to 6 and 8) or autoclave-curing (sample 7).

FIG. 2 represents the flexural strength (modulus of rupture; in relative % compared to Sample 1) of fiber cement samples 1 to 8 as produced with the compositions represented in Table 1. Modulus of rupture was measured 29 days after production and air-curing (samples 1 to 6 and 8) or autoclave-curing (sample 7) by making use of a UTS/INSTRON apparatus (type 3345; cel=5000N).

FIG. 3 represents the flexural strength (modulus of rupture; in relative % compared to Sample 9) of fiber cement samples 9 to 11 as produced with the compositions represented in Table 4. Modulus of rupture was measured 29 days after production and air-curing by making use of a UTS/INSTRON apparatus (type 3345; cel=5000N).

FIGS. 4, 5 and 11 show fiber cement decking products according to the present invention, which were manufactured by adding one or more pigments on the sieve of the Hatschek machine during the formation of one or more upper fiber cement films. As can be seen from the pictures in FIGS. 4, 5 and 11, this results in a patchy marble-like coloured pattern.

FIGS. 6 to 10 show fiber cement decking products with an embossed surface decorative pattern according to the present invention.

FIG. 12 show fiber cement decking products with an abrasively blasted surface decorative pattern according to the present invention.

FIG. 13 show fiber cement decking products with an engraved surface decorative pattern according to the present invention.

FIG. 14 shows a pre-carbonated fiber cement product (left) according to the procedure described in Example 5 and a non-pre-carbonated fiber cement product (right; Ref) not submitted to the procedure described in Example 5.

FIG. 15 shows the same pre-carbonated and non-pre-carbonated fiber cement products as shown in FIG. 14 after submission for 3000 hrs in a Weather-Ometer, which corresponds to about 10 years of natural outside exposure.

The same reference signs refer to the same, similar or analogous elements in the different figures.

### DESCRIPTION OF ILLUSTRATIVE EMBODIMENTS

The present invention will be described with respect to particular embodiments.

It is to be noted that the term “comprising”, used in the claims, should not be interpreted as being restricted to the means listed thereafter; it does not exclude other elements or steps. It is thus to be interpreted as specifying the presence of the stated features, steps or components as referred to, but does not preclude the presence or addition of one or more other features, steps or components, or groups thereof. Thus, the scope of the expression “a device comprising means A and B” should not be limited to devices consisting only of components A and B. It means that with respect to the present invention, the only relevant components of the device are A and B.

Throughout this specification, reference to “one embodiment” or “an embodiment” is made. Such references indicate that a particular feature, described in relation to the embodiment is included in at least one embodiment of the present invention. Thus, appearances of the phrases “in one embodiment” or “in an embodiment” in various places throughout this specification are not necessarily all referring to the same embodiment, though they could. Furthermore, the particular features or characteristics may be combined in any suitable manner in one or more embodiments, as would be apparent to one of ordinary skill in the art.

The following terms are provided solely to aid in the understanding of the invention.

As used herein, the singular forms “a”, “an”, and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or method steps.

The recitation of numerical ranges by endpoints includes all numbers and fractions subsumed within the respective ranges, as well as the recited endpoints.

The term “about” as used herein when referring to a measurable value such as a parameter, an amount, a temporal duration, and the like, is meant to encompass variations of +/−10% or less, preferably +/−5% or less, more preferably +/−1% or less, and still more preferably +/−0.1% or less of and from the specified value, insofar such variations are appropriate to perform in the disclosed invention. It is to be understood that the value to which the modifier “about” refers is itself also specifically, and preferably, disclosed.

The terms “(fiber) cementitious slurry” or “(fiber) cement slurry” as referred to herein generally refer to slurries at least comprising water, fibers and cement. The fiber cement slurry as used in the context of the present invention may also further comprise other components, such as but not limited to, limestone, chalk, quick lime, slaked or hydrated lime, ground sand, silica sand flour, quartz flour, amorphous silica, condensed silica fume, microsilica, metakaolin, wollastonite, mica, perlite, vermiculite, aluminum hydroxide, pigments, anti-foaming agents, flocculants, and other additives.

“Fiber(s)” present in the fiber cement slurry as described herein may be, for example, process fibers and/or reinforcing fibers which both may be organic fibers (typically cellulose fibers) or synthetic fibers (polyvinylalcohol, polyacrilonitrile, polypropylene, polyamide, polyester, polycarbonate, etc.).

“Cement” present in the fiber cement slurry as described herein may be, for example, but is not limited to Portland cement, cement with high alumina content, Portland cement of iron, trass-cement, slag cement, plaster, calcium silicates formed by autoclave treatment and combinations of particular binders. In more particular embodiments, cement in the products of the invention is Portland cement.

A “(fiber cement) sheet” as used herein, also referred to as a panel or a plate, is to be understood as a flat, usually rectangular element, a fiber cement panel or fiber cement sheet being provided out of fiber cement material. The panel or sheet has two main faces or surfaces, being the surfaces with the largest surface area. The sheet can be used to provide an outer surface to walls, both internal as well as external, a building or construction, e.g. as façade plate, siding, etc.

The invention will now be further explained in detail with reference to various embodiments. It will be understood that each embodiment is provided by way of example and is in no way limiting to the scope of the invention. In this respect, it will be clear to those skilled in the art that various modifications and variations can be made to the present invention without departing from the scope or spirit of the invention. For instance, features illustrated or described as part of one embodiment, can be used in another embodiment to yield a still further embodiment. Thus, it is intended that the present invention covers such modifications and variations as encompassed within the scope of the appended claims and equivalents thereof.

In the context of the present invention, fiber cement products are to be understood as cementitious products comprising cement and synthetic (and optionally natural) fibers. The fiber cement products are made out of fiber cement slurry, which is formed in a so-called “green” fiber cement product, and then cured.

Dependent to some extent on the curing process used, the fiber cement slurry typically comprises water, process or reinforcing fibers which are synthetic organic fibers (and optionally also natural organic fibers, such as cellulose), cement (e.g. Portland cement), limestone, chalk, quick lime, slaked or hydrated lime, ground sand, silica sand flour, quartz flour, amorphous silica, condensed silica fume, microsilica, kaolin, metakaolin, wollastonite, mica, perlite, vermiculite, aluminum hydroxide (ATH), pigments, anti-foaming agents, flocculants, and/or other additives. Optionally color additives (e.g. pigments) are added, to obtain a fiber cement product which is so-called colored in the mass.

In particular embodiments, the fiber cement products of the invention have a thickness of between about 4 mm and about 200 mm, in particular between about 6 mm and about 200 mm, more in particular between about 8 mm and about 200 mm, most in particular between about 10 mm and about 200 mm.

The fiber cement products as referred to herein include roof or wall covering products made out of fiber cement, such as fiber cement sidings, fiber cement boards, flat fiber cement sheets, corrugated fiber cement sheets and the like. According to particular embodiments, the fiber cement products according to the invention can be roofing or façade elements, flat sheets or corrugated sheets.

The fiber cement products of the present invention generally comprise from about 0.1 to about 8 weight %, such as particularly from about 0.5 to about 4 weight % of fibers, such as more particularly between about 1 to 3 weight % of fibers with respect to the total weight of the fiber cement product.

According to particular embodiments, the fiber cement products according to the invention are characterized in that they comprise fibers chosen from the group consisting of cellulose fibers or other inorganic or organic reinforcing fibers in a weight % of about 0.1 to about 5. In particular embodiments, organic fibers are selected from the group consisting of polypropylene, polyvinylalcohol polyacrylonitrile fibers, polyethylene, cellulose fibers (such as wood or annual kraft pulps), polyamide fibers, polyester fibers, aramide fibers and carbon fibers. In further particular embodiments, inorganic fibers are selected from the group consisting of glass fibers, rockwool fibers, slag wool fibers, wollastonite fibers, ceramic fibers and the like. In further particular embodiments, the fiber cement products of the present invention may comprise fibrils fibrids, such as for example but not limited to, polyolefinic fibrils fibrids in a weight % of about 0.1 to 3, such as “synthetic wood pulp”.

According to certain particular embodiments, the fiber cement products of the present invention comprise 20 to 95 weight % cement as hydraulic binder.

Cement in the products of the invention is selected from the group consisting of Portland cement, cement with high alumina content, Portland cement of iron, trass-cement, slag cement, plaster, calcium silicates formed by autoclave treatment and combinations of particular binders. In more particular embodiments, cement in the products of the invention is Portland cement.

According to particular embodiments, the fiber cement products according to the invention optionally comprise further components. These further components in the fiber cement products of the present invention may be selected from the group consisting of water, sand, silica sand flour, condensed silica fume, microsilica, fly-ashes, amorphous silica, ground quartz, the ground rock, clays, pigments, kaolin, metakaolin, blast furnace slag, carbonates, pozzolanas, aluminium hydroxide, wollastonite, mica, perlite, calcium carbonate, and other additives (e.g. colouring additives) etc. It will be understood that each of these components is present in suitable amounts, which depend on the type of the specific fiber cement product and can be determined by the person skilled in the art. In particular embodiments, the total quantity of such further components is preferably lower than 70 weight % compared to the total initial dry weight of the composition.

Further additives that may be present in the fiber cement products of the present invention may be selected from the group consisting of dispersants, plasticizers, antifoam agents and flocculants. The total quantity of additives is preferably between about 0.1 and about 1 weight % compared to the total initial dry weight of the composition.

In a first aspect, the present invention provides a process for providing a fiber cement product, the process comprising the steps of

(a) providing an uncured fiber cement product,
(b) curing the uncured fiber cement product,
(c) optionally abrasive blasting of at least part of the surface of the cured fiber cement product,
(d) treating the cured fiber cement product with CO₂ at a concentration of 0.01 to 100%, at a temperature of 5 to 90° C., relative humidity of 30 to 99% for a period of 1 minute to 48 hours.

A first step in the process of the present invention is providing an uncured fiber cement product, which can be performed according to any method known in the art for preparing building products.

In the case of a fiber cement substrate, a fiber cement slurry can first be prepared by one or more sources of at least cement, water and fibers. In certain specific embodiments, these one or more sources of at least cement, water and fibers are operatively connected to a continuous mixing device constructed so as to form a cementitious fiber cement slurry. In particular embodiments, when using cellulose fibers or the equivalent of waste paper fibers, a minimum of about 3%, such as about 4%, of the total slurry mass of these cellulose fibers is used. In further particular embodiments, when exclusively cellulose fibers are used, between about 4% to about 12%, such as more particularly, between about 7% and about 10%, of the total slurry mass of these cellulose fibers is used. If cellulose fibers are replaced by short mineral fibers such as rock wool, it is most advantageous to replace them in a proportion of 1.5 to 3 times the weight, in order to maintain approximately the same content per volume. In long and cut fibers, such as glass fiber rovings or synthetic high-module fibers, such as polypropylene, polyvinyl acetate, polycarbonate or acrylonitrile fibers the proportion can be lower than the proportion of the replaced cellulose fibers. The freeness of the fibers (measured in Shopper-Riegler degrees) is in principle not critical to the processes of the invention. Yet in particular embodiments, it has been found that a range between about 15 DEG SR and about 45 DEG SR can be particularly advantageous for the processes of the invention.

Once a fiber cement slurry is obtained, the manufacture of the fiber-reinforced cement products can be executed according to any known procedure. The process most widely used for manufacturing fiber cement products is the Hatschek process, which is performed using a modified sieve cylinder paper making machine. Other manufacturing processes include the Magnani process, injection, extrusion, flow-on and others. In particular embodiments, the fiber cement products of the present invention are provided by using the Hatschek process. The “green” or uncured fiber cement product is optionally post-compressed usually at pressures in the range from about 22 to about 30 MPa to obtain the desired density.

The obtained fiber cement products are subsequently cured according to standard processes known in the art. According to a preferred embodiment of the present invention the fiber cement products are cured to such a degree so as to provide the fiber cement product with the required physico-mechanical properties.

The fiber cement products can be allowed to cure over a time in the environment in which they are formed, or alternatively can be subjected to a thermal cure (at atmospheric pressure or by autoclaving).

In further particular embodiments, the “green” fiber cement product is cured, typically by curing to the air at atmospheric pressure (air cured fiber cement products) or under pressure in presence of steam and increased temperature (autoclave cured). For autoclave cured products, typically silica sand is added to the original fiber cement slurry. The autoclave curing in principle results in the presence of a.o. 11.3 Å (angstrom) Tobermorite in the fiber cement product.

In yet further particular embodiments, the “green” fiber cement product may be first pre-cured to the air, after which the pre-cured product is further air-cured until it has its final strength, or autoclave-cured using pressure and steam, to give the product its final properties.

In case the fiber cement products of the present invention are fully air cured generally step (b) involves allowing the products to cure in air over a time period of at least 7 days, preferably at least 14 days, most preferably at least one month.

In particular embodiments of the present invention, the process may further comprise, after the curing step, the step of (at least partial) drying of the obtained fiber cement products. After curing, the fiber cement product being a panel, sheet or plate, may still comprise a significant weight of water, present as humidity. This may be up to 10 even 15% wt, expressed per weight of the dry product. The weight of dry product is defined as the weight of the product when the product is subjected to drying at 105° C. in a ventilated furnace, until a constant weight is obtained.

Such drying is done preferably by air drying and is terminated when the weight percentage of humidity of the fiber cement product is less than or equal to 8 weight %, even less than or equal to 6 weight %, expressed per weight of dry product, and most preferably between 4 weight % and 6 weight %, inclusive.

In a subsequent step at least part of surface of the cured fiber cement product is optionally abrasively blasted. According to a preferred embodiment the fiber cement products of the present invention are abrasively blasted before treating the product with CO₂.

Abrasive blasting in the context of the present invention is the abrasion of a surface by forcibly propelling a stream of abrasive material or a stream of abrasive particles against the surface to be treated under high pressure. Such abrasive particles may be mineral particles (e.g. but not limited to sand, garnet, magnesium sulphate, kieserlite, . . . ), natural or organic particles (such as but not limited to crushed nut shells or fruit kernels, . . . ), synthetic particles (such as but not limited to corn starch or wheat starch and alike, sodium bicarbonate, dry ice and alike, copper slag, nickel slag, or coal slag, aluminum oxide or corundum, silicon carbide or carborundum, glass beads, ceramic shot/grit, plastic abrasive, glass grit, and alike), metal grid (such as but not limited to steel shot, steel grit, stainless steel shot, stainless steel grit, corundum shot, corundum grit, cut wire, copper shot, aluminum shot, zinc shot) and any combination of these.

According to other particular embodiments of the invention, the abrasive blasting is abrasive shotblasting performed by using for example a shot blasting wheels turbine, which propels a stream of high velocity particles, such as metal particles, against the surface to be treated using centrifugal force.

According to certain particular embodiments of the invention, the abrasive blasting is sand blasting performed by using a sand blaster machinery, which propels a stream of high velocity sand sized particles against the surface to be treated using gas under pressure.

Subsequent to the blasting the surface is usually washed to remove dust.

Step (d) of the process of the present invention involves treating the cured fiber cement product with CO₂ (so-called carbonation) at a concentration of 0.01 to 100% by volume, at a temperature of 5 to 90° C., relative humidity of 30 to 99% for a period of 1 minute to 48 hours at atmospheric pressure or higher pressure (such as, for example, up to 5 bar).

Generally said treatment takes place in a climate room at the temperature, relative humidity and CO₂ concentrations mentioned above.

According to an embodiment of the present invention the cured fiber cement product is treated with CO₂ at a concentration of 1 to 30%, preferably 5 to 20%.

According to another embodiment of the present invention the treatment with CO₂ takes place at a temperature of 30 to 70° C., preferably 20 to 60° C.

According to another embodiment of the present invention the treatment with CO₂ takes place at a relative humidity of 70 to 95%, preferably 40 to 95%.

According to another embodiment of the present invention the treatment with CO₂ takes place over a period of at least 2 minutes or even at least 5 minutes or even at least 10 minutes or even at least 15 minutes. Said carbonation treatment preferably takes less than 24 hours or less than 16 hours or less than 8 hours or less than 4 hours or less than 2 hours or less than 1 hour.

According to a particularly preferred embodiment of the present invention the carbonation takes place for a duration of between 1 hour and 8 hours, at a concentration of CO₂ of about 30%, a temperature of about 60° C. and a relative humidity of about 95%.

In a second aspect, the present invention provides the fiber cement products obtained by said process.

In a third aspect, the present invention provides the use of the abovementioned CO₂ treatment to limit or prevent the occurrence of efflorescence on the outer surface of fiber cement products exposed to a humid environment.

In a fourth aspect, the present invention provides the use of the obtained fiber cement products as covering of a building construction.

### EXAMPLES

It will be appreciated that the following examples, given for purposes of illustration, are not to be construed as limiting the scope of this invention. Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention that is defined in the following claims and all equivalents thereto. Further, it is recognized that many embodiments may be conceived that do not achieve all of the advantages of some embodiments, yet the absence of a particular advantage shall not be construed to necessarily mean that such an embodiment is outside the scope of the present invention.

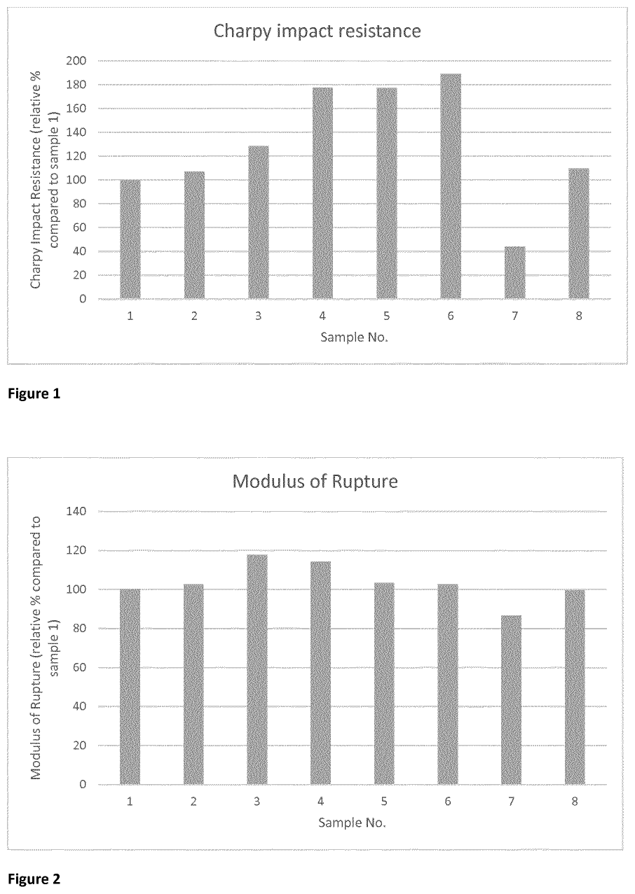

It will become clear from the experimental results as described below that the fiber cement products of the present invention are characterized by the fact that undesirable efflorescence defects (which are caused by exposure to humidity or to weathering during outside exposure) are completely or essentially absent (i.e. do not occur) when these products are submitted to the presently claimed process prior to being exposed to known efflorescence-inducing circumstances or conditions (i.e. humidity, weathering . . . ). In addition, the products according to the present invention were demonstrated to have a high flexural modulus (as shown in FIGS. 1 to 3).

As will also become clear from the results described below, these beneficial properties are effectuated by the specific fiber cement composition of the fiber cement products of the present invention as described in detail below.

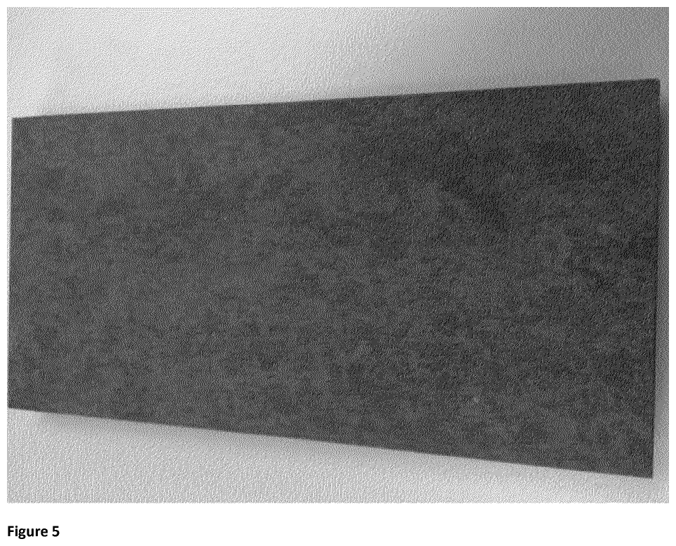

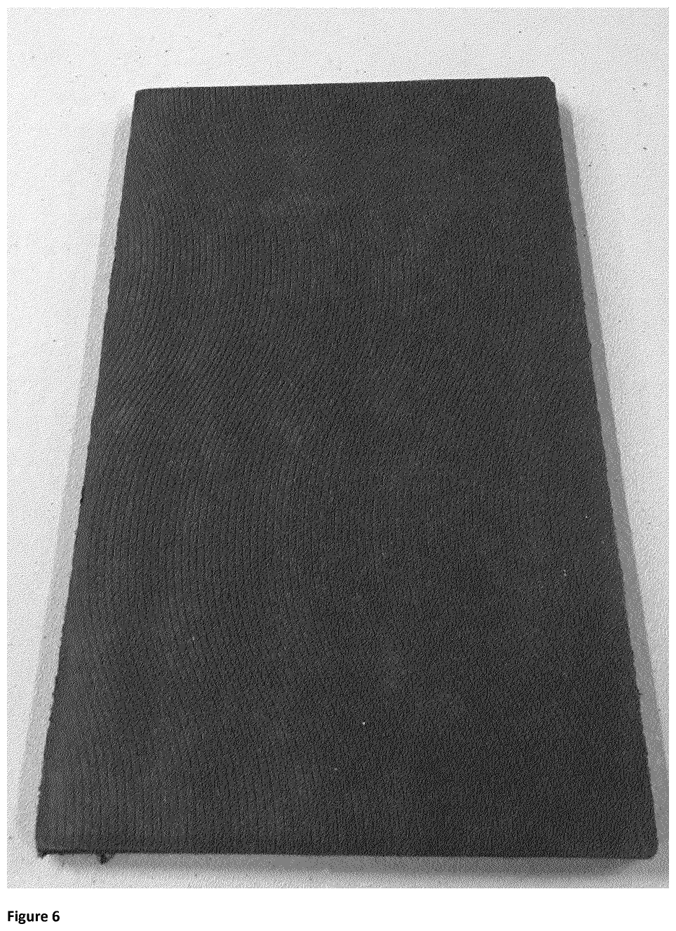

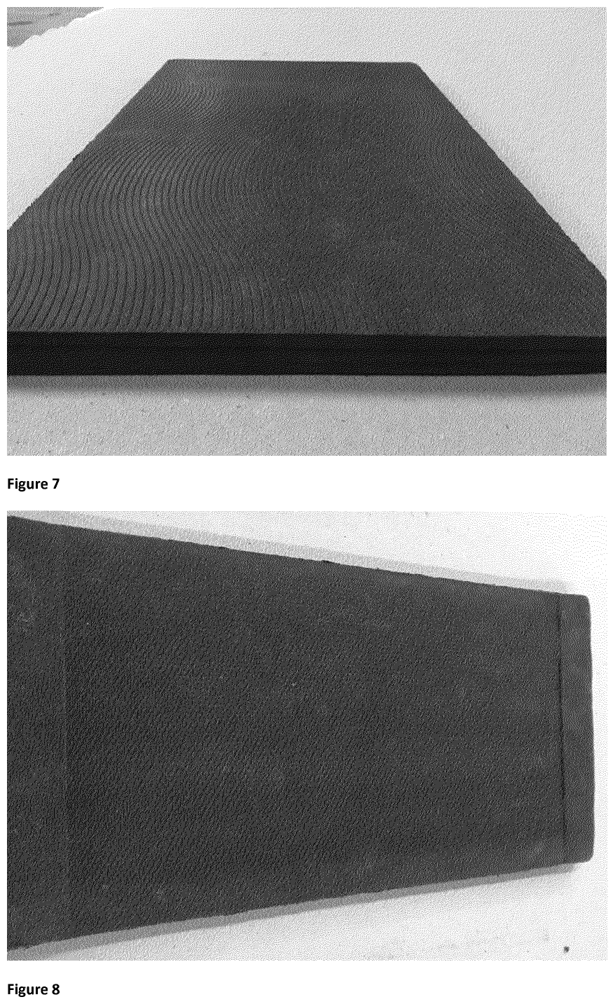

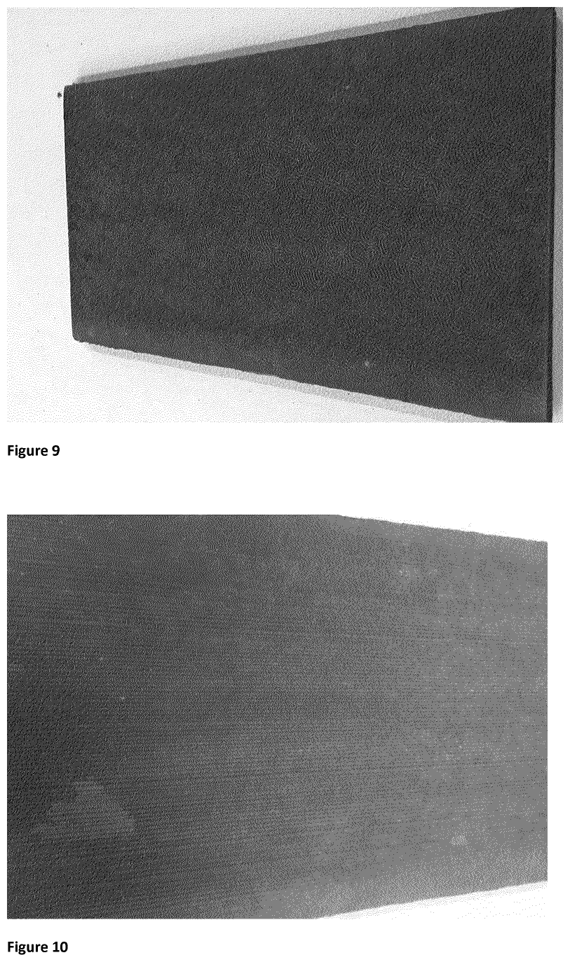

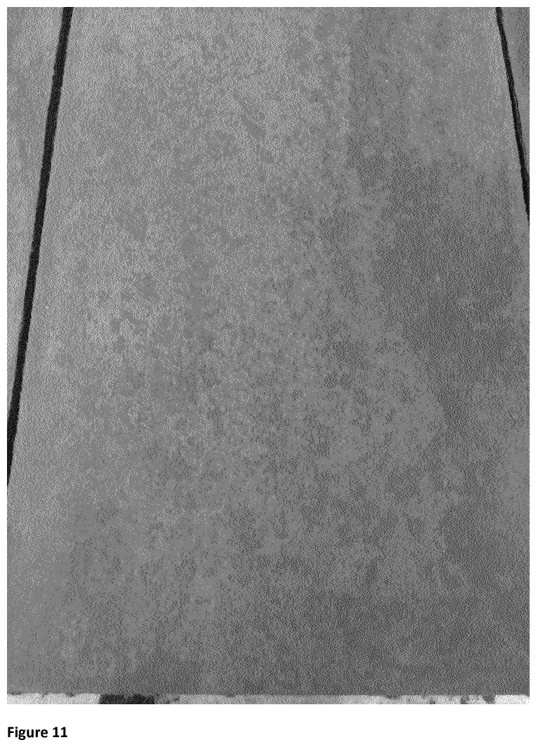

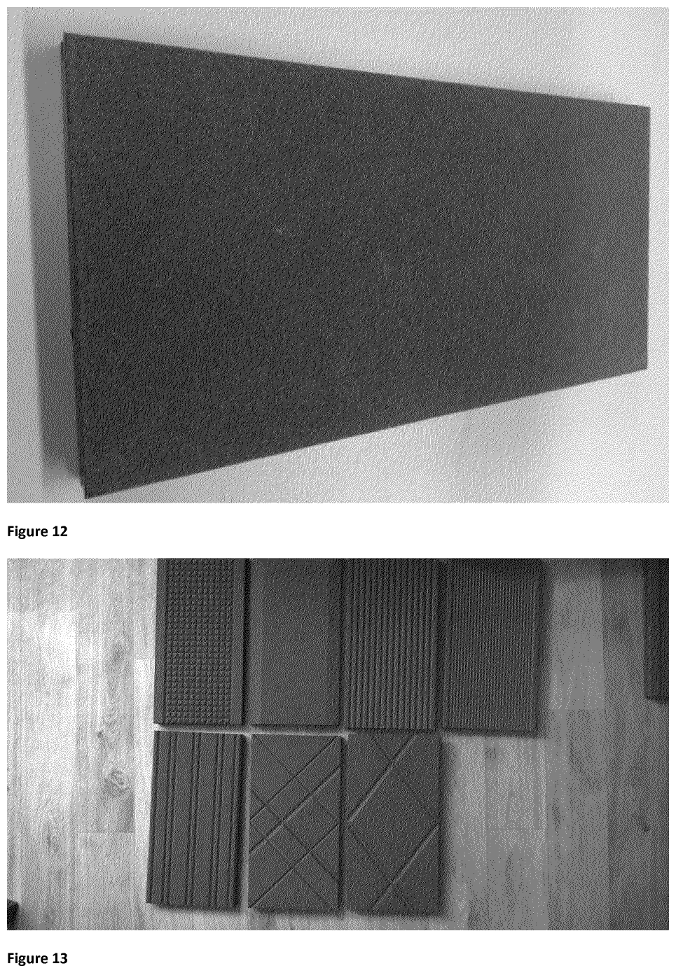

In addition, the fiber cement products as described in the Examples have an attractive esthetic appearance because of their mass-coloured aspect and their original decorative surface pattern (as shown in FIGS. 4 to 13).

### Example 1: Effect of the Fiber Composition on the Mechanical Properties of the Fiber Cement Products According to the Present Invention

Fiber cement products were produced with the methods of the present invention as described herein according to the following specific embodiments.

### 1.1 Materials & Methods

### 1.1.1 Production of Fiber Cement Slurry Samples

Different formulations of an aqueous fiber cement slurry were prepared as shown in Table 1. Other additives may have been added to these formulations, without being essential to the findings of the present invention.

### 1.1.2 Manufacture of Fiber Cement Product on Mini-Hatschek Machine

Cementitious products were manufactured by the Hatschek technique according to a pilot process reproducing the main characteristics of the products obtained by the industrial process.

The green sheets of samples 1 to 6 and 8 were pressed at 230 kg/cm² and air-cured by subjecting them to a curing at 60° C. for 8 hours, and thereafter curing at ambient conditions. Sample 7 was not air-cured but autoclave-cured for a total of 9 hours, at a pressure between 100 to 150 psi and at a temperature of 148 to 177 degrees Celsius.

After two weeks, the formed fiber cement products were analyzed for their physico-mechanical characteristics, i.e. Charpy impact resistance and flexural strength.

### 1.1.3 Measurement of the Charpy Impact Resistance

The Charpy impact resistance was measured according to standard ASTM D-256-81, using an apparatus Zwick DIN 5102.100/00 on air-dry mini-Hatschek samples of 15 mm*120 mm and a span of 100 mm.

Each of the mini-Hatschek samples were measured in two directions (machine direction and direction perpendicular to this) two weeks after the production.

The impact resistance of the same samples was again measured after ageing in an oven of 600 L at 60° C. and 90% of relative humidity, with injection of 1.5 L CO₂/min during 24 hours. The CO₂ concentration ranges thus from 7% at the beginning of conditioning to 12% at the end of conditioning.

### 1.1.4 Measurement of the Flexural Strength

The modulus of rupture (MOR; typically expressed in Pa=kg/m·s²) of each of the mini-Hatschek samples was measured by making use of a UTS/INSTRON apparatus (type 3345; cel=5000N).

### 1.2 Results

### 1.2.1 Charpy Impact Resistance of the Fiber Cement Products of the Present Invention

Table 2 and FIG. 1 show the results that were obtained with regard to the Charpy impact resistance of fiber cement products produced with the fiber cement compositions of samples 1 to 8 as presented in Table 1 using the methods of the present invention. The results in Table 2 were derived from average values from several sample tests. It was observed that the Charpy impact resistance of the obtained fiber cement products was significantly improved for air-cured samples comprising synthetic fibers (i.e. all samples vs. sample 7, which was an autoclave-cured sample, exclusively containing natural cellulose fibers). Samples 4, 5 and 6, comprising a combination of different types of synthetic fibers, namely a combination of polypropylene fibers combined with polyvinyl alcohol fibers, performed particularly well (see FIG. 1).

TABLE 1
FC formulations M % samples 1 to 8 (PVA: polyvinyl alcohol; PP: polypropylene; pigment black iron oxide:
Omnixon M21320; pigment brown iron oxide: Omnixon EB 31683; ATH: aluminiumtrihydroxide). M % refers to
the mass of the component over the total mass of all components except free water, i.e. the dry matter.

| Ingredient | | | | | | | | |
|---|---|---|---|---|---|---|---|---|
| (in M %) | Sample 1 | Sample 2 | Sample 3 | Sample 4 | Sample 5 | Sample 6 | Sample 7 | Sample 8 |
| Cement | 79.40 | 79.40 | 79.30 | 78.80 | 78.80 | 80.70 | 29.50 | 79.40 |
| Trass (filler) | 5.00 | 5.00 | 5.00 | 5.00 | 5.00 | 5.00 | 0.00 | 5.00 |
| Black iron oxide | 6.75 | 6.75 | 6.75 | 6.75 | 6.75 | 6.75 | 3.38 | 6.75 |
| Brown iron oxide | 2.25 | 2.25 | 2.25 | 2.25 | 2.25 | 2.25 | 1.12 | 2.25 |
| Cellulose fibers | 2.80 | 2.80 | 2.80 | 2.80 | 2.80 | 2.80 | 7.35 | 2.80 |
| *Low strength PVA | 1.90 | 0.00 | 0.00 | 0.00 | 0.00 | 0.00 | 0.00 | 1.90 |
| fibers 2 dtex | | | | | | | | |
| **High strength PVA | 0.00 | 1.90 | 1.00 | 1.00 | 0.50 | 0.50 | 0.00 | 0.00 |
| fibers 2 dtex | | | | | | | | |
| PVA fibers 7 dtex | 0.00 | 0.00 | 1.00 | 1.00 | 1.00 | 1.00 | 0.00 | 0.00 |
| PP fibers | 0.00 | 0.00 | 0.00 | 0.50 | 1.00 | 1.00 | 0.00 | 0.00 |
| Quartz | 0.00 | 0.00 | 0.00 | 0.00 | 0.00 | 0.00 | 37.25 | 0.00 |
| Kaolin | 0.00 | 0.00 | 0.00 | 0.00 | 0.00 | 0.00 | 3.90 | 0.00 |
| ATH | 0.00 | 0.00 | 0.00 | 0.00 | 0.00 | 0.00 | 3.90 | 0.00 |
| Limestone | 0.00 | 0.00 | 0.00 | 0.00 | 0.00 | 0.00 | 7.80 | 0.00 |
| Wollastonite | 0.00 | 0.00 | 0.00 | 0.00 | 0.00 | 0.00 | 5.80 | 0.00 |
| Additives | 1.90 | 1.90 | 1.90 | 1.90 | 1.90 | 0.00 | 0.00 | 1.90 |

*Tenacity of low strength PVA fibers of 2 dtex = 11 to 13 cN/dtex
**Tenacity of high strength PVA fibers of 2 dtex = 13 to 15 cN/dtex

TABLE 2
Relative % values for the Charpy impact
resistance of fiber cement products obtained
according to the methods of the invention

| | Charpy impact of fiber cement |
|---|---|
| Sample | (in relative % compared to |
| (see Table 1) | Sample 1) |
| 1 | 100.00 |
| 2 | 106.96 |
| 3 | 128.41 |
| 4 | 177.44 |
| 5 | 177.16 |
| 6 | 188.86 |
| 7 | 44.011 |
| 8 | 109.47 |

### 1.2.2 Flexural Strength

Table 3 and FIG. 2 show the results that were obtained with regard to the mechanical strength of fiber cement products produced with the fiber cement compositions of samples 1 to 8 as presented in Table 1 using the methods of the present invention. The results in Table 3 were derived from average values from several sample tests. It was observed that the modulus of rupture of the obtained fiber cement products was significantly improved for air-cured samples comprising synthetic fibers (i.e. all samples vs. sample 7, which was an autoclave-cured sample, exclusively containing natural cellulose fibers). Samples 4, 5 and 6, comprising a combination of different types of synthetic fibers, namely a combination of polypropylene fibers combined with polyvinyl alcohol fibers, performed particularly well (see FIG. 2).

TABLE 3
Relative % values for the modulus of
rupture of fiber cement products obtained
according to the methods of the invention

| | sMOR (relative % |
|---|---|
| | compared to sample 1) |
| Sample | (measured under saturated |
| (see Table 1) | conditions) |
| 1 | 100.00 |
| 2 | 102.61 |
| 3 | 117.69 |
| 4 | 114.26 |
| 5 | 103.33 |
| 6 | 102.66 |
| 7 | 86.68 |
| 8 | 99.64 |

### 1.3 Conclusion

To conclude, it is clear that fiber cement products manufactured according to the present invention show improved mechanical properties. In particular, air-cured fiber cement products comprising synthetic fibers show a very good impact resistance and a high flexural strength when compared to autoclave-cured products not containing any synthetic fibers.

### Example 2: Effect of Amorphous Silica on the Mechanical Properties of the Fiber Cement Products According to the Present Invention

Fiber cement products were produced with the methods of the present invention as described herein according to the following specific embodiments.

### 2.1 Materials & Methods

### 2.1.1 Production of Fiber Cement Slurry Samples

Different formulations of an aqueous fiber cement slurry were prepared as shown in Table 4. Other additives may have been added to these formulations, without being essential to the findings of the present invention.

TABLE 4
FC formulations M % samples 9 to 11 (PVA:
polyvinyl alcohol; pigment black iron oxide: Omnixon
M21320; pigment brown iron oxide: Omnixon EB 31683).
M % refers to the mass of the component over the total mass
of all components except free water, i.e. the dry matter.

| Ingredient (in | | | |
|---|---|---|---|
| M %) | Sample 9 | Sample 10 | Sample 11 |
| Cement | 83.90 | 84.90 | 81.90 |
| Trass (filler) | 5.00 | 0.00 | 0.00 |
| Black iron oxide | 3.38 | 3.38 | 3.38 |
| Brown iron oxide | 1.13 | 1.13 | 1.13 |
| Cellulose fibers | 2.80 | 2.80 | 2.80 |
| *Low strength PVA | 1.90 | 1.90 | 1.90 |
| fibers 2 dtex | | | |
| Amorphous silica | 0.00 | 4.00 | 7.00 |
| Additives | 1.89 | 1.89 | 1.89 |

*Tenacity of low strength PVA fibers of 2 dtex = 11 to 13 cN/dtex

### 2.1.2 Manufacture of Fiber Cement Product on Mini-Hatschek Machine

Cementitious products were manufactured by the Hatschek technique according to a pilot process reproducing the main characteristics of the products obtained by the industrial process.

The green sheets of samples 9 to 11 were pressed at 230 kg/cm² and air-cured by subjecting them to a curing at 60° C. for 8 hours, and thereafter curing at ambient conditions. After two weeks, the formed fiber cement products were analyzed for their physico-mechanical characteristics.

### 2.1.4 Measurement of the Flexural Strength

The modulus of rupture (MOR; typically expressed in Pa=kg/m·s²) of each of the mini-Hatschek samples was measured by making use of a UTS/INSTRON apparatus (type 3345; cel=5000N).

### 2.2 Results

### 2.2.1 Flexural Strength

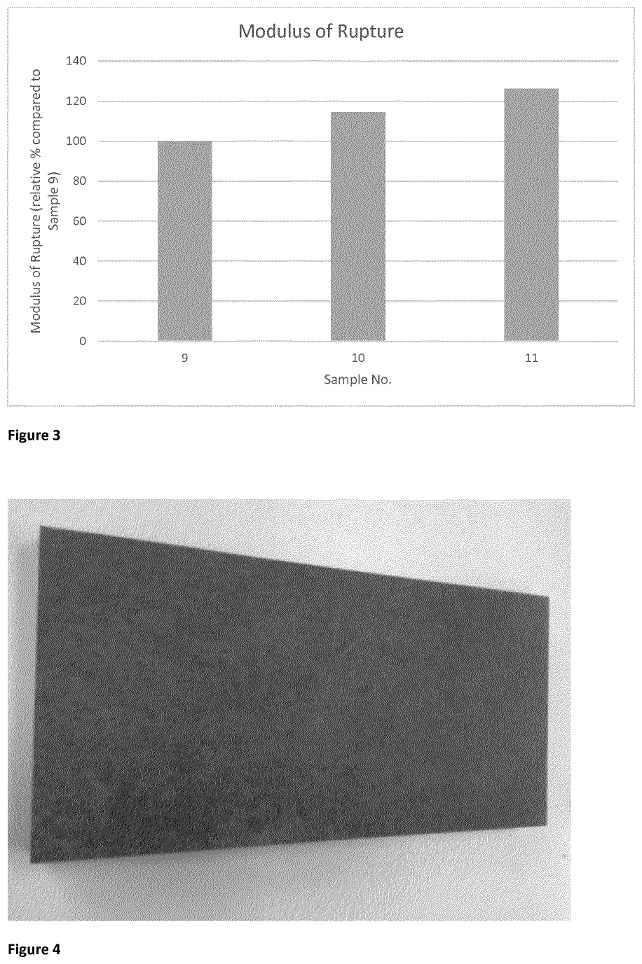

Table 5 and FIG. 3 show the results that were obtained with regard to the mechanical strength of fiber cement products produced with the fiber cement compositions of samples 9 to 11 as presented in Table 4 using the methods of the present invention. The results in Table 5 represent average values from several sample tests. It was observed that the modulus of rupture of the obtained fiber cement products was significantly improved for air-cured samples comprising amorphous silica, in particular in amounts between about 4 weight % and about 7 weight % (weight % compared to the total dry weight of the fiber cement composition).

TABLE 5
Modulus of rupture (relative % compared to
sample 9) of fiber cement products obtained
according to the methods of the invention

| | sMOR (relative % |
|---|---|
| | compared to sample 9) |
| Sample | (measured under |
| (see Table 4) | saturated conditions) |
| 9 | 100.00 |
| 10 | 114.38 |
| 11 | 126.14 |

### 2.3 Conclusion

The above results showed that the fiber cement products manufactured according to the present invention show improved mechanical properties. In particular, air-cured fiber cement products comprising amorphous silica show a higher flexural strength when compared to products not containing amorphous silica. In particular, products comprising amounts between about 4 weight % and about 7 weight % of amorphous silica perform very well.

### Example 3: Effect of Amorphous Silica on the Freeze-Thaw Stability of the Fiber Cement Products According to the Present Invention

Fiber cement products were produced with the methods of the present invention as described herein according to the following specific embodiments.

### 3.1 Materials & Methods

### 3.1.1 Production of Fiber Cement Slurry Samples

Different formulations of an aqueous fiber cement slurry were prepared as shown in Table 6. Other additives may have been added to these formulations, however without being essential to the findings of the present invention.

### 3.1.2 Manufacture of Fiber Cement Product on Mini-Hatschek Machine

Cementitious products were manufactured by the Hatschek technique according to a pilot process reproducing the main characteristics of the products obtained by the industrial process.

The green sheets of samples 12 to 15 were pressed at 230 kg/cm² and air-cured by subjecting them to a curing at 60° C. for 8 hours, and thereafter curing at ambient conditions. Sample 16 was not air-cured but autoclave-cured for a total of 9 hours, at a pressure between 100 to 150 psi and at a temperature of 148 to 177 degrees Celsius.

After two weeks, the formed fiber cement products were analyzed for their dimensional stability, i.e. by performing freeze-thaw tests as described below.

### 3.1.3 Measurement of the Dimensional Stability by Means of Freeze-Thaw Testing

The dimensional stability of samples 12 to 16 was determined using the following procedure. Pre-conditioning of the samples was done before performing the freeze thaw tests. To this end, samples of 100 mm×280 mm (sawed edges) were immersed in water during 3 days. Then, the thickness of the samples was measured and corresponded to the measurement after 0 cycles (reference thickness). Afterwards, samples were subjected to max. 300 freeze-thaw cycles. During the freeze thaw cycles, the samples were maintained alternatingly at −20° C.±3° C. (freeze temperature in a freezer having a temperature of about −20° C.) and at +20° C.±3° C. (thaw temperature of a tray with water in which the samples were immersed) each time for a period of at least 1 hour. During cycling, the temperature in the freezer and in the copper trays was logged. After each 10 to 30 cycles the thickness of the samples was measured and checked for possible defects.

TABLE 6
FC formulations M % samples 12 to 16 (PVA: polyvinyl
alcohol; PP: polypropylene; pigment black iron oxide:
Omnixon M21320; pigment brown iron oxide: Omnixon
EB 31683; ATH: aluminiumtrihydroxide). M % refers to
the mass of the component over the total mass of
all components except free water, i.e. the dry matter.

| | Sam- | Sam- | Sam- | Sam- | Sam- |
|---|---|---|---|---|---|
| Ingredient | ple | ple | ple | ple | ple |
| (in M%) | 12 | 13 | 14 | 15 | 16 |
| Cement | 83.90 | 76.90 | 74.90 | 78.80 | 29.50 |
| Trass (filler) | 5.00 | 5.00 | 0.00 | 5.00 | 0.00 |
| Black iron oxide | 3.38 | 3.38 | 3.38 | 6.75 | 3.38 |
| Brown iron oxide | 1.12 | 1.12 | 1.12 | 2.25 | 1.12 |
| Cellulose fibers | 2.80 | 2.80 | 2.80 | 2.80 | 7.35 |
| *Low strength | 1.90 | 1.90 | 1.90 | 0.00 | 0.00 |
| PVA fibers 2 dtex | | | | | |
| **High strength | 0.00 | 0.00 | 0.00 | 1.00 | 0.00 |
| PVA fibers 2 dtex | | | | | |
| PVA fibers | 0.00 | 0.00 | 0.00 | 1.00 | 0.00 |
| 7 dtex | | | | | |
| PP fibers | 0.00 | 0.00 | 0.00 | 0.50 | 0.00 |
| Quartz | 0.00 | 0.00 | 0.00 | 0.00 | 37.25 |
| Kaolin | 0.00 | 0.00 | 0.00 | 0.00 | 3.90 |
| ATH | 0.00 | 0.00 | 0.00 | 0.00 | 3.90 |
| Limestone | 0.00 | 0.00 | 7.00 | 0.00 | 7.80 |
| Wollastonite | 0.00 | 0.00 | 0.00 | 0.00 | 5.80 |
| Amorphous silica | 0.00 | 7.00 | 7.00 | 0.00 | 0.00 |
| Additives | 1.90 | 1.90 | 1.90 | 1.90 | 0.00 |

*Tenacity of low strength PVA fibers of 2 dtex = 11 to 13 cN/dtex
**Tenacity of high strength PVA fibers of 2 dtex = 13 to 15 cN/dtex

### 3.2 Results

### 3.2.1 Dimensional Stability of the Fiber Cement Products of the Present Invention

Table 7 shows the results that were obtained with regard to the dimensional stability of fiber cement products produced with the fiber cement compositions of samples 12 to 16 as presented in Table 6 using the methods of the present invention. The results in Table 7 were derived from average values from several sample tests. It was observed that the dimensional stability of the obtained fiber cement products was significantly improved for air-cured samples comprising amorphous silica. Indeed, it is clear from Table 7 that samples 13 and 14 (comprising 7% of amorphous silica) only show a very small increase in thickness after 192 freeze-thaw cycles when compared to the other samples not containing any amorphous silica. It is noted that the autoclave-cured samples were completely disintegrated after 138 freeze-thaw cycles and thus further measurements could not be done.

TABLE 7
Dimensional changes of the fiber cement samples 12 to
16, expressed in increase of thickness in % values

| Sample | Thickness increase (in %) after x cycles | | | | | | | | |
|---|---|---|---|---|---|---|---|---|---|
| (see Table 6) | x = 0 | x = 14 | x = 28 | x = 57 | x = 84 | x = 112 | x = 138 | x = 167 | x = 192 |
| 12 | 0.00 | 0.15 | 0.30 | 0.39 | 0.67 | 1.44 | 2.43 | 3.61 | 4.69 |
| 13 | 0.00 | 0.19 | 0.38 | 0.34 | 0.31 | 0.37 | 0.43 | 0.58 | 0.41 |
| 14 | 0.00 | 0.25 | 0.43 | 0.41 | 0.35 | 0.43 | 0.50 | 0.60 | 0.63 |
| 15 | 0.00 | 0.13 | 0.09 | 0.17 | 0.17 | 1.38 | 1.98 | 2.62 | 3.14 |
| 16 | 0.00 | 0.26 | 0.55 | 2.68 | 4.11 | 6.01 | 7.41 | No | No |
| | | | | | | | | value | value |

### 3.3 Conclusion

To conclude, the fiber cement products manufactured according to the present invention show improved mechanical properties. In particular, air-cured fiber cement products comprising about 7% of amorphous silica show a very good dimensional stability when compared to samples not containing amorphous silica.

### Example 4: Effect of the Fiber Composition on the Charpy Impact Resistance of the Fiber Cement Products According to the Present Invention

Fiber cement products were produced with the methods of the present invention as described herein according to the following specific embodiments.

### 4.1 Materials & Methods

### 4.1.1 Production of Fiber Cement Slurry Samples

Different formulations of an aqueous fiber cement slurry were prepared as shown in Tables 8 and 9. Other additives may have been added to these formulations, however without being essential to the findings of the present invention.

TABLE 8
FC formulations M % samples 17 to 23 (PVA: polyvinyl alcohol; PP: polypropylene;
pigment black iron oxide: Omnixon M21320; pigment brown iron oxide: Omnixon
EB 31683; ATH: aluminiumtrihydroxide). M % refers to the mass of the component
over the total mass of all components except free water, i.e. the dry matter.

| Ingredient | | | | | | | |
|---|---|---|---|---|---|---|---|
| (in M %) | Sample 17 | Sample 18 | Sample 19 | Sample 20 | Sample 21 | Sample 22 | Sample 23 |
| Cement | 79.40 | 79.30 | 78.80 | 29.50 | 81.30 | 81.75 | 81.75 |
| Trass (filler) | 5.00 | 5.00 | 5.00 | 0.00 | 0.00 | 0.00 | 0.00 |
| Black iron oxide | 6.75 | 6.75 | 6.75 | 3.38 | 3.38 | 3.38 | 3.38 |
| Brown iron oxide | 2.25 | 2.25 | 2.25 | 1.12 | 1.12 | 1.12 | 1.12 |
| Cellulose fibers | 2.80 | 2.80 | 2.80 | 7.35 | 2.80 | 2.80 | 2.80 |
| *Low strength PVA | 1.90 | 0.00 | 0.00 | 0.00 | 0.00 | 0.00 | 0.00 |
| fibers 2 dtex | | | | | | | |
| **High strength PVA | 0.00 | 1.00 | 1.00 | 0.00 | 1.00 | 0.00 | 0.00 |
| fibers 2 dtex | | | | | | | |
| PVA fibers 4 dtex | 0.00 | 0.00 | 0.00 | 0.00 | 0.00 | 1.00 | 2.50 |
| PVA fibers 7 dtex | 0.00 | 1.00 | 1.00 | 0.00 | 1.00 | 1.50 | 0.00 |
| PP fibers | 0.00 | 0.00 | 0.50 | 0.00 | 0.50 | 0.50 | 0.50 |
| Quartz | 0.00 | 0.00 | 0.00 | 37.25 | 0.00 | 0.00 | 0.00 |
| Kaolin | 0.00 | 0.00 | 0.00 | 3.90 | 0.00 | 0.00 | 0.00 |
| ATH | 0.00 | 0.00 | 0.00 | 3.90 | 0.00 | 0.00 | 0.00 |
| Limestone | 0.00 | 0.00 | 0.00 | 7.80 | 0.00 | 0.00 | 0.00 |
| Wollastonite | 0.00 | 0.00 | 0.00 | 5.80 | 0.00 | 0.00 | 0.00 |
| Amorphous silica | 0.00 | 0.00 | 0.00 | 0.00 | 7.00 | 7.00 | 7.00 |
| Additives | 1.90 | 1.90 | 1.90 | 0.00 | 1.90 | 0.95 | 0.95 |

*Tenacity of low strength PVA fibers of 2 dtex = 11 to 13 cN/dtex
**Tenacity of high strength PVA fibers of 2 dtex = 13 to 15 cN/dtex

### 4.1.2 Manufacture of Fiber Cement Product on Mini-Hatschek Machine

Cementitious products were manufactured by the Hatschek technique according to a pilot process reproducing the main characteristics of the products obtained by the industrial process.

The green sheets of samples 17 to 23 were pressed at 230 kg/cm² and air-cured by subjecting them to a curing at 60° C. for 8 hours, and thereafter curing at ambient conditions. Sample 20 was not air-cured but autoclave-cured for a total of 9 hours, at a pressure between 100 to 150 psi and at a temperature of 148 to 177 degrees Celsius (see Table 8).

After two weeks, the formed fiber cement products were analyzed for their Charpy impact resistance.

### 4.1.3 Manufacture of Fiber Cement Product on an Industrial Hatschek Machine

Cementitious products were manufactured by an industrial Hatschek process. The green sheets of samples 24 and 25 were pressed at 230 kg/cm² and air-cured by subjecting them to a curing at 60° C. for 8 hours, and thereafter curing at ambient conditions (see Table 9). After two weeks, the formed fiber cement products were analyzed for their Charpy impact resistance.

TABLE 9
FC formulations M % samples 24 and 25 (PVA:
polyvinyl alcohol; PP: polypropylene; pigment black
iron oxide: Omnixon M21320; pigment brown iron oxide:
Omnixon EB 31683; ATH: aluminiumtrihydroxide).
M % refers to the mass of the component over the total
mass of all components except free water, i.e. the dry matter.

| Ingredient | Sample | Sample |
|---|---|---|
| (in M %) | 24 | 25 |
| Cement | 83.90 | 81.29 |
| Trass (filler) | 5.00 | 0.00 |
| Black iron | 3.38 | 3.38 |
| oxide | | |
| Brown iron | 1.12 | 1.12 |
| oxide | | |
| Cellulose | 2.80 | 2.80 |
| fibers | | |
| *Low | 1.90 | 0.00 |
| strength | | |
| PVA fibers | | |
| 2 dtex | | |
| **High | 0.00 | 1.00 |
| strength | | |
| PVA fibers | | |
| 2 dtex | | |
| PVA fibers | 0.00 | 1.00 |
| 7 dtex | | |
| PP fibers | 0.00 | 0.50 |
| Quartz | 0.00 | 0.00 |
| Kaolin | 0.00 | 0.00 |
| ATH | 0.00 | 0.00 |
| Limestone | 0.00 | 0.00 |
| Wollastonite | 0.00 | 0.00 |
| Amorphous | 0.00 | 0.00 |
| silica | | |
| Additives | 1.90 | 1.90 |

*Tenacity of low strength PVA fibers of 2 dtex = 11 to 13 cN/dtex
**Tenacity of high strength PVA fibers of 2 dtex = 13 to 15 cN/dtex

### 4.2 Results

4.2.1 Measurement of the Charpy impact resistance

The Charpy impact resistance was measured according to standard ASTM D-256-81, using an apparatus Zwick DIN 5102.100/00 on air-dry mini-Hatschek samples of 15 mm*120 mm and a span of 100 mm. Each of the samples 17 to 25 were measured in two directions (machine direction and direction perpendicular to this) two weeks after the production.

The impact resistance of the same samples was again measured after ageing in an oven of 600 L at 60° C. and 90% of relative humidity, with injection of 1.5 L CO₂/min during 24 hours. The CO₂ concentration ranges thus from 7% at the beginning of conditioning to 12% at the end of conditioning.

### 4.2.2 Charpy Impact Resistance of the Fiber Cement Products of the Present Invention

Table 10 shows the results that were obtained with regard to the Charpy impact resistance of fiber cement products produced with the fiber cement compositions of samples 17 to 25 as presented in Tables 8 and 9 using the methods of the present invention. The results in Table 10 were derived from average values from several sample tests. It was observed that the Charpy impact resistance of the obtained fiber cement products was significantly improved for air-cured samples comprising synthetic fibers (i.e. all samples vs. sample 20, which was an autoclave-cured sample, which exclusively contained natural cellulose fibers). Samples 18, 19, 21, 22 and 23, each of which comprised a combination of different types of synthetic fibers performed particularly well when compared for instance to sample 17, containing only one type of synthetic fibers. Finally, the specific combination of one or more types of polyvinyl alcohol (PVA) fibers with polypropylene (PP) fibers resulted in fiber cement products with a particularly high impact resistance. This is clear from the mini-hatschek trials when comparing sample 19 and samples 21 to 23 (comprising PVA and PP fibers) to for instance sample 17 (only containing PVA fibers). The same is true for the samples obtained from the industrial trials, where sample 25 (comprising a combination of PVA and PP fibers) clearly has a significantly improved impact resistance over sample 24 (only comprising PVA fibers).

TABLE 10
Charpy impact resistances (in kJ/m²) of fiber
cement products obtained according to
the methods of the invention

| Sample | Charpy impact of |
|---|---|
| (see Tables 8 | fiber cement |
| and 9) | (in kJ/m²)) |
| 17 | 3.12 |
| 18 | 3.44 |
| 19 | 5.44 |
| 20 | 1.58 |
| 21 | 5.68 |
| 22 | 6.66 |
| 23 | 8.57 |
| 24 | 4.20 |
| 25 | 7.63 |

### 4.3 Conclusion

To conclude, it is clear that fiber cement products manufactured according to the present invention show substantially improved mechanical properties as compared to known fiber cement products. In particular, air-cured fiber cement products comprising synthetic fibers show a very good impact resistance. In addition, air-cured fiber cement products comprising a combination of different types of synthetic fibers, especially a combination of polyvinyl alcohol fibers and polypropylene fibers perform best.

### Example 5: Pre-Carbonation Process to Avoid the Occurrence of Efflorescence on the Surface of Fiber Cement Products

Air-cured fiber cement samples 26 to 38 (produced in the same way as described above in Examples 1 to 4) were submitted to different pre-carbonation procedures under the conditions as given in Table 1.

After being submitted to the different pre-carbonation treatments, the samples were put into a weatherometer for 3000 hrs, which corresponds to natural outside exposure of about 10 years.

TABLE 1
Test conditions used for pre-carbonation of air-cured
fiber cement samples 26 to 38 as compared to a
non-pre-carbonated reference sample (Ref)

| | | | | | Visible |
|---|---|---|---|---|---|
| | | | | Duration | efflorescence |
| | | | Humid- | of | after 3000 hrs in |
| Sam- | CO₂ | T | ity | exposure | Weather-Ometer |
| ple | % | (° C.) | (%) | (min) | (WOM) |
| Ref | n.a. | n.a. | n.a. | n.a. | yes |
| 26 | 2.5 | 60 | >90 | 90 | yes |
| 27 | 5 | 60 | >90 | 90 | yes |
| 28 | 10 | 60 | >90 | 90 | yes |
| 29 | 2.5 | 60 | >90 | 90 | yes |
| 30 | 5 | 60 | >90 | 90 | yes |
| 31 | 10 | 60 | >90 | 90 | yes |
| 32 | 20 | 60 | >90 | 120 | no |
| 33 | 10 | 40 | 80 | 120 | yes |
| 34 | 50 | 40 | 80 | 240 | yes |
| 35 | 50 | 60 | 80 | 360 | yes |
| 36 | 20 | 60 | 80 | 360 | no |
| 37 | 50 | 60 | 80 | 360 | yes |
| 38 | 20 | 60 | 80 | 360 | no |

From the Table 1 above, it is clear that the best results (i.e. no visible efflorescence) were obtained by using a pre-carbonation process combining the following conditions:
1) Relative humidity equal to or higher than 80%, preferably higher than 90%, preferably higher than 95%;
2) Temperature equal to or higher than 40° C., preferably between 40° C. and 60° C., more preferably about 60° C.;
3) CO₂ concentration of equal to or lower than about 30% (in volume), preferably between 15% (in volume) and 30% (in volume), more preferably about 20% (in volume);
4) Exposure to the above conditions 1), 2) and 3) of between 1 to 12 hrs.

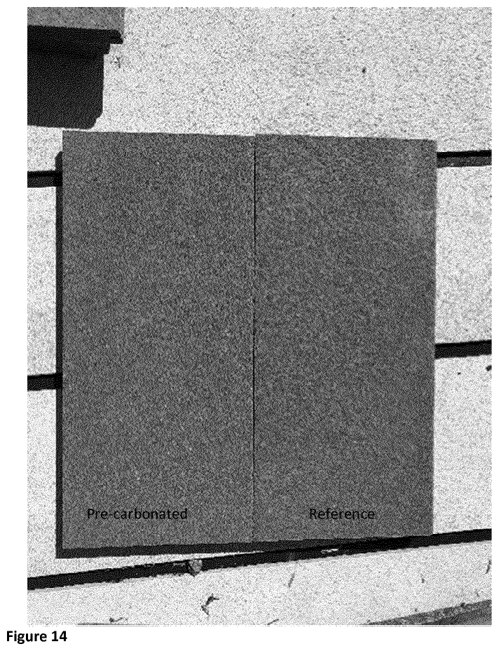

FIG. 14 shows a pre-carbonated fiber cement product corresponding to sample 32 in Table 1 (left sample in FIG. 14) and non-pre-carbonated fiber cement product corresponding to sample Ref in Table 1 (right sample in FIG. 14).

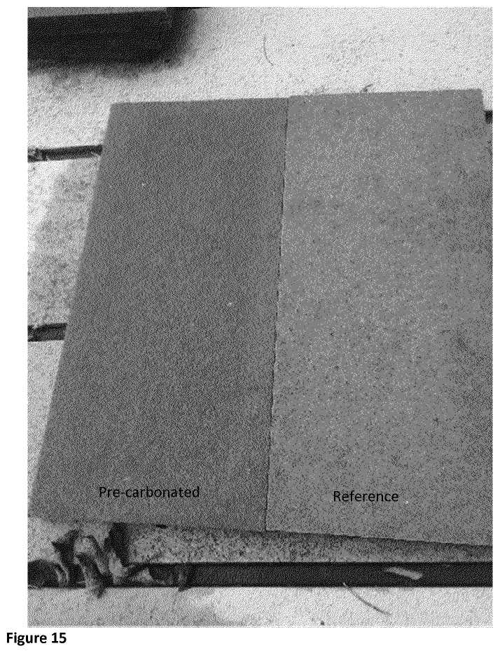

FIG. 15 shows the same pre-carbonated and non-pre-carbonated fiber cement products as shown in FIG. 14 after submission for 3000 hrs in a Weather-Ometer, which corresponds to about 10 years of natural outside exposure.

1. Process for providing a fiber cement product, comprising the steps of
(a) providing an uncured fiber cement product,
(b) curing the uncured fiber cement product,
(c) optionally abrasive blasting of at least part of the surface of the cured fiber cement product, and
(d) treating the cured fiber cement product with CO2 at a concentration of 0.01 to 100% by volume, at a temperature of 5 to 90° C., relative humidity of 30 to 99% for a period of 1 minute to 48 hours.

2. Process according to claim 1, wherein in step (d) the concentration of CO₂ is between 1 and 30% by volume, preferably 5 to 20% by volume.

3. Process according to claim 1, wherein step (d) takes place at a temperature of 20 to 60° C.

4. Process according to claim 1, wherein step (d) takes place at a relative humidity of 40 to 95%.

5. Process according to claim 1, wherein step (d) takes place during a period of between 1 hour and 8 hours.

6. Process according to claim 1, wherein step (b) involves allowing the product to cure in air over a time period of at least 7 days, preferably at least 14 days, most preferably at least one month.

7. Fiber cement products obtainable by the process as defined in claim 1.

8. Process as defined in claim 1, comprising the additional step of covering a building construction with the fiber cement product.

9. Process for limiting or preventing the occurrence of efflorescence on the outer surface of fiber cement products exposed to a humid environment, comprising treating a cured fiber cement product with CO₂ at a concentration of 0.01 to 100% by volume, at a temperature of 5 to 90° C., relative humidity of 30 to 99% for a period of 1 minute to 48 hours.

10. Process according to claim 2, wherein step (d) takes place at a temperature of 20 to 60° C.

11. Process according to claim 10, wherein step (d) takes place at a relative humidity of 40 to 95%.

12. Process according to claim 3, wherein step (d) takes place at a relative humidity of 40 to 95%.

13. Process according to claim 2, wherein step (d) takes place at a relative humidity of 40 to 95%.

14. Process according to claim 13, wherein step (d) takes place during a period of between 1 hour and 8 hours.

15. Process according to claim 12, wherein step (d) takes place during a period of between 1 hour and 8 hours.

16. Process according to claim 11, wherein step (d) takes place during a period of between 1 hour and 8 hours.

17. Process according to claim 10, wherein step (d) takes place during a period of between 1 hour and 8 hours.

18. Process according to claim 4, wherein step (d) takes place during a period of between 1 hour and 8 hours.

19. Process according to claim 3, wherein step (d) takes place during a period of between 1 hour and 8 hours.

20. Process according to claim 2, wherein step (d) takes place during a period of between 1 hour and 8 hours.
